(19) United States
(12) Patent Application Publication
(10) Pub. No.: US 2005/0017388 A1
(43) Pub. Date: Jan. 27, 2005

(54) Method for producing plastic profiles

(76) Inventors: Martin Jirka, Kirchdorf (AT); Robert Gassner, Bad Hall (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/890,515

(22) Filed: Jul. 14, 2004

(30) Foreign Application Priority Data
Jul. 15, 2003 (AT) A 1099/2003

(51) Int. Cl. B29C 47/90; B29C 47/92

(52) U.S. Cl. 264/40.1; 425/135

(57) ABSTRACT

The invention relates to a method for producing plastic profiles, in which a strand of plastic is produced in an extruder and is cooled and calibrated in at least one calibrating tool by use of vacuum. A rapid and secure recognition of fissures in profiles is achieved in such a way that the vacuum pressure is monitored and, when a predetermined limit value is exceeded, a signal is emitted indicative of a fissure in the profile. The invention further relates to an apparatus for performing the method.

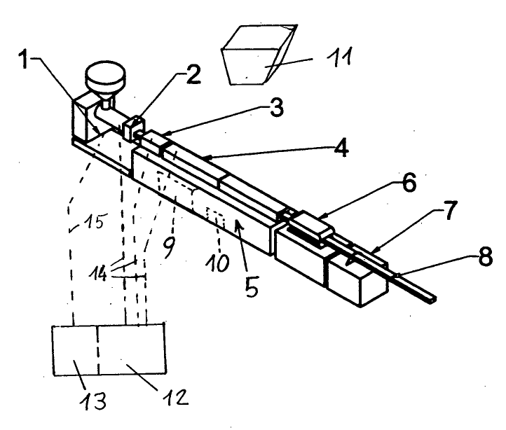

### TECHNICAL FIELD

The invention relates to a method for producing plastic profiles, in which a strand of plastic is produced in an extruder and is cooled and calibrated in at least one calibrating tool by use of vacuum.

Methods for producing plastic profiles have been continually developed in the past years in order to achieve higher outputs through high draw-off speeds. As a result, the production processes have become more critical in many cases. A fissure in the profile cannot be entirely avoided even when the process is guided in a careful manner. In order to minimize damage, it is necessary at first to recognize the fissure in the profile as quickly as possible in order to take suitable measures. Monitoring must be reliable, but may only cause little effort.

### PRIOR ART

From U.S. Pat. No. 5,008,051 A an apparatus has become known for calibrating plastic profiles in which the pressure in the vacuum system is controlled electronically. This allows keeping the pressure in a region which is optimal for the profile quality. Error recognition is not possible however.

### OBJECT OF THE INVENTION

It is the object of the present invention to further develop the method in such a way that in the case of a fissure in the profile the damage can be kept as low as possible. It is a further object of the invention to provide an apparatus for producing plastic profiles with which this method can be implemented.

### DISCLOSURE OF THE INVENTION

These objects are achieved in accordance with the invention in such a way that the vacuum pressure is monitored and, when a predetermined limit value is exceeded, a signal is emitted indicative of a fissure in the profile.

An important aspect of the invention is that it is possible, with minimal effort, to detect a fissure in a profile. It is especially advantageous in this connection that the fissure in the profile can be detected more quickly than with mechanical or optical apparatuses which have an idle time in the detection.

An immediate measure for the immediate treatment of the incident is made when the signal is supplied to a drive device which displaces the calibrating table in the downstream direction. This makes the profile strand accessible in order to allow manual intervention.

Generally, the profile discharge from the extruder cannot be stopped immediately without causing any damage to the extruder. It is especially preferable, in order to avoid any undesirable back-up, when the signal ensures that the profile is guided into a disposal container.

The invention further relates to an apparatus for producing plastic profiles with an extruder and with at least one calibrating tool in which the profile is cooled and calibrated by using vacuum.

This apparatus is characterized in accordance with the invention in such a way that a monitoring device for the pressure in the calibrating tool is provided which emits a signal when the pressure exceeds a predetermined limit value in order to indicate that a fissure in the profile is present. Such an apparatus can be realized with minimum effort.

A dry calibrating apparatus is preferably provided downstream of the extruder, which apparatus is provided with a vacuum system with vacuum slots. The monitoring device is connected to the vacuum system of the dry calibrating apparatus. A fissure in the profile can thus be detected at an especially early stage.

It is possible in addition or as an alternative thereto that a wet calibrating apparatus is provided which is connected to a vacuum source and that the monitoring device is connected to the vacuum system of the vacuum source.

A further automation of the troubleshooting can be achieved in such a way that the monitoring device is connected to a control device which is configured to power down the extruder according to a predetermined program upon receiving a signal indicative of a fissure in the profile.

The present invention allows detecting incidents with little effort and to troubleshoot such incidents. The production of rejects can thus be minimized.

### BRIEF DESCRIPTION OF THE DRAWING

The invention is now explained in closer detail by reference to drawing which schematically shows an apparatus in accordance with the invention in an axonometric view.

### DETAILED DESCRIPTION OF A PREFERRED EMBODIMENT

An extruder 1 with an extrusion die 2 is in connection with extrusion tools 3, 4 which are arranged on a calibrating table. The extrusion tools 3, 4 concern a dry calibrating apparatus 3 and a wet calibrating apparatus 4 which cool and calibrate the produced profile 8. In order to have improved access in the region between the extruder 1 and the extrusion tools 3, 4 during the start-up of the extrusion line and in the case malfunctions, the calibrating table 5 is displaceable in the longitudinal direction. A drive device 10 is provided for this purpose.

A vacuum pump 9 is used as a vacuum source in order to supply the extrusion tools 3, 4 with the required vacuum. The vacuum is applied in the dry calibrating apparatus 3 via slots (not shown) onto the outside wall of the profile in order to press the same against the tool. The profile 8 is pulled in the usual way by a caterpillar pull-off 6 through the extrusion tools 3, 4 and severed into profile sections by a saw or guillotine 8.

A monitoring device 12 is in connection via lines 14 with the extruder 1, the dry calibrating apparatus 3 and the wet calibrating apparatus 4, with the vacuum pressure being monitored and transmitted in particular. If a fissure in the profile is detected, a disposal container 11 is provided in order to accept the reject on the one hand and a control device 13 is made to issue signals via control lines 15 on the other hand in order to power down the extruder 1 in a proper fashion.

The present invention allows detecting malfunctions with little effort and ensuring that the problems are solved. The production of rejects can thus be minimized.

1. A method for producing plastic profiles, in which a strand of plastic is produced in an extruder and is cooled and calibrated in at least one calibrating tool by use of vacuum, wherein the vacuum pressure is monitored and, when a predetermined limit value is exceeded, a signal is emitted indicative of a fissure in the profile.

2. A method as claimed in claim 1, wherein the signal is supplied to a drive device which displaces the calibrating table in the downstream direction.

3. A method as claimed in claim 1, wherein the signal ensures that the profile is supplied to a disposal container.

4. An apparatus for producing plastic profiles with an extruder and with at least one calibrating tool in which the profile is cooled and calibrated by using vacuum, wherein a monitoring device for the pressure in the calibrating tool is provided which emits a signal when the pressure exceeds a predetermined limit value in order to indicate that a fissure in the profile is present.

5. An apparatus as claimed in claim 4, wherein the monitoring device is connected to a driver device which is configured to displace the calibrating table in the downstream direction.

6. An apparatus as claimed in claim 4, wherein the monitoring device is connected to a disposal container in order to receive the profile in the case of a fissure in the profile.

7. An apparatus as claimed in claim 4, wherein a dry calibrating apparatus is provided downstream of the extruder which is provided with a vacuum system with vacuum slots and that the monitoring device is connected to the vacuum system of the dry calibrating apparatus.

8. An apparatus as claimed in claim 4, wherein An apparatus as claimed in claim 4, wherein a wet calibrating apparatus is provided which is connected to a vacuum source and that the monitoring device is connected to the vacuum system of the vacuum source.

9. An apparatus as claimed in claim 4, wherein the monitoring device is connected to a control device which is configured to power down the extruder according to a predetermined program upon receiving a signal indicative of a fissure in the profile.
